(19) United States
(12) Patent Application Publication
(10) Pub. No.: US 2016/0178515 A1
(43) Pub. Date: Jun. 23, 2016

(54) A DEVICE FOR ANALYSING A SPECIMEN USING THE GOOS-HANCHEN SURFACE PLASMON RESONANCE EFFECT

(71) Applicant: NATIONAL UNIVERSITY OF SINGAPORE, Singapore (SG)

(72) Inventors: Fong Yau Sam Li, Singapore (SG); Huanan Wu, Singapore (SG)

(21) Appl. No.: 14/896,776

(22) PCT Filed: Jun. 19, 2014
(86) PCT No.: PCT/SG2014/000292

§ 371 Date: Dec. 8, 2015

(30) Foreign Application Priority Data
Jun. 25, 2013 (SG) 201304999-4

(51) Int. Cl. G01N 21/552; G01N 21/21

(52) U.S. Cl. CPC G01N 21/553; G01N 21/21; G01N 2201/06113; G01N 2201/022

(57) ABSTRACT

A device (100) for analysing a specimen using the Goos-Hänchen surface plasmon resonance effect is disclosed. The device comprises a housing (102); a sensor (116) for internally reflecting a coherent light beam and for receiving the specimen; an optical means (112, 114) for directing the coherent light beam at the sensor to enable interaction between the internally reflected coherent light beam and the received specimen to cause the internally reflected coherent light beam to be shifted; and a detector (120) for detecting the shifted coherent light beam, the sensor being integrally formed with the housing. Related methods of operating and manufacturing the device are also disclosed.

### FIELD

The present invention relates to a device for analysing a specimen using the Goos-Hänchen surface plasmon resonance effect.

### BACKGROUND

Surface plasmon resonance (SPR) sensors [1] are a standard tool used for various applications in analytical science and technologies. A typical SPR sensor includes a glass prism coated with a thin layer of gold in which an exposed portion becomes a sensing surface. When a polarized light beam is internally reflected by the glass/gold interface of said sensing surface, electromagnetic field of the polarized light beam partially penetrates into the gold layer and builds up an evanescent wave field. After re-emerging from the glass surface, the actual reflected energy flux is laterally displaced with respect to the geometrical optics beam, and this observation is known as the Goos-Hänchen (GH) effect [2]. The maximum longitudinal beam displacement is usually extremely small. However, large longitudinal beam shifts may be achieved using SPR devices, as the evanescent wave can couple to and excite a surface plasmon wave at the sensing surface [3].

It is highlighted that the Goos-Hänchen SPR's detection principle, based on displacement of polarized light, is different from that used in conventional SPR sensors based on the Kretschmann configuration [4], in which internally reflected light from surface plasmon polaritons in a metal film bounded at one side by a prism and from the other opposing side by air is measured. Moreover, conventional SPR sensors are bulky and exposed to the environment, thus making them unsuitable for outdoor applications.

One object of the present invention is therefore to address at least one of the problems of the prior art and/or to provide a choice that is useful in the art.

### SUMMARY

According to a 1^{st} aspect of the invention, there is provided a device for analysing a specimen using the Goos-Hänchen surface plasmon resonance effect, the device comprising a housing; a sensor for internally reflecting a coherent light beam and for receiving the specimen; an optical means for directing the coherent light beam at the sensor to enable interaction between the internally reflected coherent light beam and the received specimen to cause the internally reflected coherent light beam to be shifted; and a detector for detecting the shifted coherent light beam, the sensor being integrally formed with the housing.

Advantageously, the proposed device provides that the sensor, optical means and detector are compactly arranged within the housing (which is light and water-proof) to provide a modular device. Via this arrangement, the device is thus able to substantially eliminate interferences from the environment during performance of measurements, and also beneficially allows the device to be submerged into liquids for taking direct measurements.

Preferably, the housing may be arranged to be impervious to visible light and water. The optical means may include a reflection mirror and a focusing lens arranged in a cooperative relationship. In addition, the device may further comprise a means for generating the coherent light beam, which may include a laser source configured to alternately generate a P-polarized coherent light beam or S-polarized coherent light beam, or a laser source configured to generate a P-polarized coherent light beam. Moreover, the device may also further comprise a processor for processing signals generated by the detector based on detection of the shifted coherent light beam, wherein the processor is configured to divide the signals into a plurality of secondary signals with reference to an original pulse and an amplitude-inverted pulse of the original pulse for noise reduction and signal amplification.

Preferably, the detector may include a position sensitive detector.

The laser source may preferably include a first laser diode configured to generate a P-polarized laser beam, a second laser diode configured to generate an S-polarized laser beam, a modulation means for modulating the P-polarized laser beam and S-polarized laser beam, and a polarizing beam splitter arranged to optically couple the modulated P-polarized laser beam and S-polarized laser beam to obtain a coupled laser beam.

Alternatively, the laser source may include a laser diode configured to generate a non-polarized laser beam, a first polarizing beam splitter arranged to optically split the non-polarized laser beam into a P-polarized laser beam and a S-polarized laser beam, a modulation means for modulating the P-polarized laser beam and S-polarized laser beam, and a second polarizing beam splitter arranged to optically couple the modulated P-polarized laser beam and S-polarized laser beam to obtain a coupled laser beam.

The modulation means may include at least two optical choppers for respectively modulating the P-polarized laser beam and S-polarized laser beam, the optical choppers configured to be driven by 180°-out-of-phase square waves. Optionally, the modulation means may include at least one perpendicular optical chopper for modulating both the P-polarized laser beam and S-polarized laser beam.

Yet further alternatively, the laser source may include a laser diode configured to generate a polarized laser beam, a P-polarizer to optically polarize the polarized laser beam to obtain a P-polarized laser beam, and a modulation means for modulating the P-polarized laser beam.

Preferably, the modulation means may include at least one optical chopper. The sensor may include a plurality of optical surfaces for internally reflecting the coherent light beam, at least one of the plurality of optical surfaces is metallically coated to increase an amount of the internal reflection of the coherent light beam.

Preferably, the sensor may include an optical prism configured with the plurality of optical surfaces, or an optical substrate configured with the plurality of optical surfaces, or an optical substrate configured with a plurality of raised features corresponding to the plurality of optical surfaces.

The plurality of optical surfaces may include at least two optical surfaces. Optionally, at least one of the plurality of optical surfaces may be arranged to further include a porous layer. Also, wherein the at least one of the plurality of optical surfaces is metallically coated may include being arranged to be coated with gold or silver.

According to a 2^{nd} aspect of the invention, there is provided a method of analysing a specimen using the Goos-Hänchen surface plasmon resonance effect by using the device based on the said 1^{st} aspect, wherein the specimen is received by the sensor, the method comprises directing a coherent light beam at the integrally formed sensor using the optical means; internally reflecting the coherent light beam using the sensor to enable interaction between the internally reflected coherent light beam and the received specimen to cause the internally reflected coherent light beam to be shifted; and detecting the shifted coherent light beam using the detector.

According to a 3^{rd} aspect of the invention, there is provided a method of manufacturing a device configured for analysing a specimen using the Goos-Hänchen surface plasmon resonance effect, the method comprises providing a sensor for internally reflecting a coherent light beam and for receiving the specimen; providing an optical means for directing the coherent light beam at the sensor to enable interaction between the internally reflected coherent light beam and the received specimen to cause the internally reflected coherent light beam to be shifted; providing a detector for detecting the shifted coherent light beam; and integrally forming the sensor with a housing and arranging the optical means and detector in the housing to obtain the device.

According to a 4^{th} aspect of the invention, there is provided a sensor for analysing a specimen using the Goos-Hänchen surface plasmon resonance effect, the sensor comprising a plurality of optical surfaces for internally reflecting a coherent light beam, wherein at least one of the plurality of optical surfaces is metallically coated to increase an amount of the internal reflection of the coherent light beam.

It should be apparent that features relating to one aspect of the invention may also be applicable to the other aspects of the invention.

Preferably, the sensor may be an optical prism configured with the plurality of optical surfaces, or an optical substrate configured with the plurality of optical surfaces, or an optical substrate configured with a plurality of raised features corresponding to the plurality of optical surfaces.

The plurality of optical surfaces may include at least two optical surfaces. Optionally, at least one of the plurality of optical surfaces may be arranged to further include a porous layer. Also, wherein the at least one of the plurality of optical surfaces is metallically coated may include being arranged to be coated with gold or silver.

These and other aspects of the invention will be apparent from and elucidated with reference to the embodiments described hereinafter.

### BRIEF DESCRIPTION OF THE DRAWINGS

Embodiments of the invention are disclosed hereinafter with reference to the accompanying drawings, in which:

FIG. 1 depicts schematics of a device for analysing a specimen using the Goos-Hänchen surface plasmon resonance (GH-SPR) effect, according to an embodiment;

FIG. 2 depicts a front view of the device of FIG. 1, together with a motorized mirror used therein;

FIGS. 3a to 3c show different sensing optics usable in the device of FIG. 1;

FIGS. 4a and 4b show further different sensing optics usable in the device of FIG. 1;

FIGS. 5a to 5e show different metal coating layers combinations adoptable for the sensing optics;

FIGS. 6a to 6f depict schematics of different configurations of laser sources usable with the device of FIG. 1;

FIG. 7 is a logic diagram of a processing circuit board used with the device of FIG. 1;

FIGS. 8a and 8b show methods of data acquisition based on the prior art and the said embodiment respectively;

FIGS. 9a and 9b are graphs showing generation and optimization of GH-SPR signals respectively; and

FIG. 10 is a graph measuring response to refractive index changes of the GH-SPR tested with NaCl solution.

### DETAILED DESCRIPTION OF PREFERRED EMBODIMENTS

Enclosed Sensor Unit

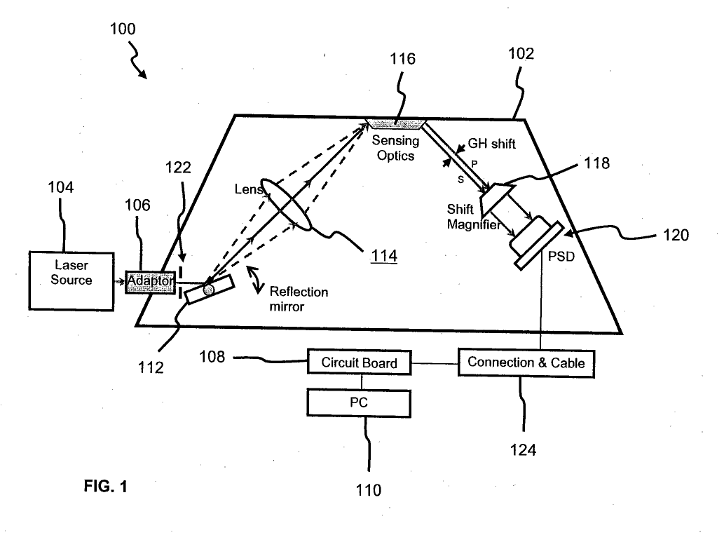

A device 100 arranged for analysing a target specimen (not shown) using the Goos-Hänchen surface plasmon resonance (GH-SPR) effect is disclosed, according to an embodiment shown in FIG. 1. The device 100 includes a housing 102 (arranged to house and enclose all necessary optical components), a suitable laser source 104, an adaptor 106 (to facilitate introduction of at least one laser beam emitted by the laser source 104 into the housing 102), and a processing circuit board 108 communicably coupled to a computing device 110 (e.g. a PC). It is to be appreciated that the laser source 104, adaptor 106, processing circuit board 108 and computing device 110 are all external to the housing 102. Also, the said necessary optical components include a reflection mirror 112, a convex lens 114, a (dielectric-based) sensing optics 116 (which includes a sensor), an (miniature) optical magnifier 118, and a position sensitive detector (PSD) 120, all of which are sequentially arranged in the housing 102 in the above described order. It is to be appreciated that the target specimen to be analysed is arranged to be in contact with the upper surface of the sensing optics 116, in which the upper surface is defined to be the surface adjacent to the wall of the housing 102 on which the sensing optics 116 is formed. Of course, depending on requirements of other applications, the target specimen may alternatively also be configured to be in contact with the lower surface of the sensing optics 116, in which the lower surface is in opposing arrangement to the said upper surface. The housing 102 is realised as a sealed plastic enclosure (in this case) and an aperture 122 (e.g. a pinhole) is provided on a portion of the housing 102 to enable regulation of a size of the laser beam introduced into the housing 102 via the adaptor 106. Of course, the housing 102 may also be formed of other suitable materials, and not necessary limited to plastic. The sensing optics 116 is also integrally formed with the housing 102, in which the integration involves appropriate moulding of the housing 102.

It is to be appreciated that SPR and GH-SPR setups involve complicated optics, and any vibrations or shift in position of optical components of the setups may result in significant interference on signals or even failure of measurement. Hence, for the proposed device 100, by integrating and housing all the necessary optical components in a compact structure (i.e. the housing 102) advantageously allows the mentioned optical components to be securely positioned so that a desired optimal configuration can be maintained. Moreover, the housing 102 also protects the setup of the mentioned optical components from any undesirable interference due to ambient light, moisture, water, electromagnetic waves and etc. Needless to say, the aperture 122 and adaptor 106 are configured with necessary liquid-proofing arrangement so that no liquid may be accidentally introduced into the housing 102 through the aperture 122 and/or adaptor 106, when the device 100 is submerged in liquids for taking measurements.

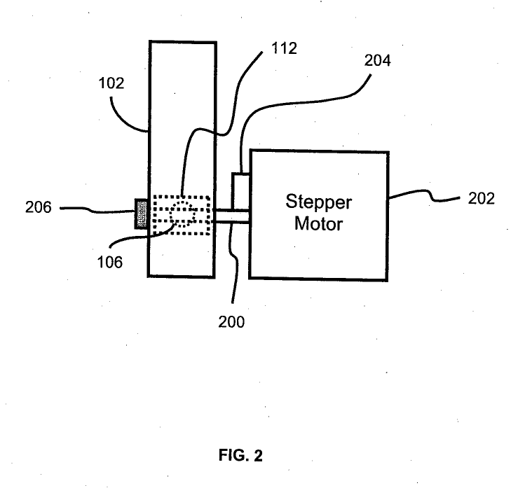

Specifically, the laser beam introduced into the housing 102 is angularly directed at a desired angle to the sensing optics 116, by using the reflection mirror 112, and convex lens 114 (which has a focal length of f), for detection. As shown in FIG. 2, the reflection mirror 112 is mounted to (along the length of) a shaft 200 of a stepper motor 202 which is arranged external to the housing 102, and so rotating the shaft 200 (on its longitudinal axis) in turn causes the reflection mirror 112 to be angularly rotated. The shaft 200 is arranged to be automatically rotated by using the stepper motor 202 (activated via an opto switch 204) or manually rotated using a tuning knob 206 arranged at a free end of the shaft 200 not connected to the stepper motor 202. Particularly, both ways of rotating the shaft 200 enables fine tuning of the angular rotation of the reflection mirror 112 with a micron level resolution, in which the fine tuning allows the laser beam to be swept within an angle range of a few degrees for optimization of incident angle. It is also to be appreciated that the tuning knob 206 is lockable at a desired position after tuning is completed. Further, the centre of the reflection mirror 112 and a detection point on the sensing optics 116 are respectively positioned at a distance of 2 f from the centre of the convex lens 114. Such a manner of arrangement ensures that the incident point is maintained even as the incident angle changes. So, by appropriately adjusting and tuning the stepper motor 202 or the tuning knob 206, the reflection mirror 112 can thus precisely be rotated to a desired angle, which allows the incident angle to approach as closely as possible to an optimal incident angle, termed as the SPR angle.

When the laser beam exits from the sensing optics 116, the laser beam is spilt into a P-polarized laser beam and an S-polarized laser beam (to be elaborated below). In this case, the surface plasmon resonance (SPR) is excited by a P-polarized laser beam and the Goos-Hänchen (GH) shift is amplified by the SPR. Approximately, the said SPR angle is slightly greater than a critical angle (α) of total internal reflection, which is determined by equation (1):

sin(α)=n1/n2 (1)

wherein n1 and n2 respectively represent refractive indexes of a sample medium and the sensing optics 116, sin( ) represents the trigonometric sine function, and also n1<n2. It is further to be appreciated that there is no GH shift of the S-polarized laser beam due to absence of surface plasmon resonance, which beneficially enables the S-polarized laser beam to be used for position referencing. The GH shift of the P-polarized laser beam is measured by monitoring relative beam displacement between the two (P-polarized and S-polarized) laser beams using the PSD 120. Before the two laser beams reach the PSD 120, the said beam displacement is first magnified by the optical magnifier 118 which also optimizes the focusing of the two laser beams onto the PSD 120 to be detected. The PSD 120 is electrically coupled (via suitable cable connections 124) to the processing circuit board 108 for necessary data acquisition (to be later processed by the computing device 110).

To clarify, the reflection mirror 112, and convex lens 114 are thus optical means for directing the laser beam at the sensing optics 116 to enable interaction between the internally reflected laser beam and the specimen to cause the internally reflected laser beam to be shifted, while the PSD 120 detects the GH-shifted laser beam.

Sensing Optics

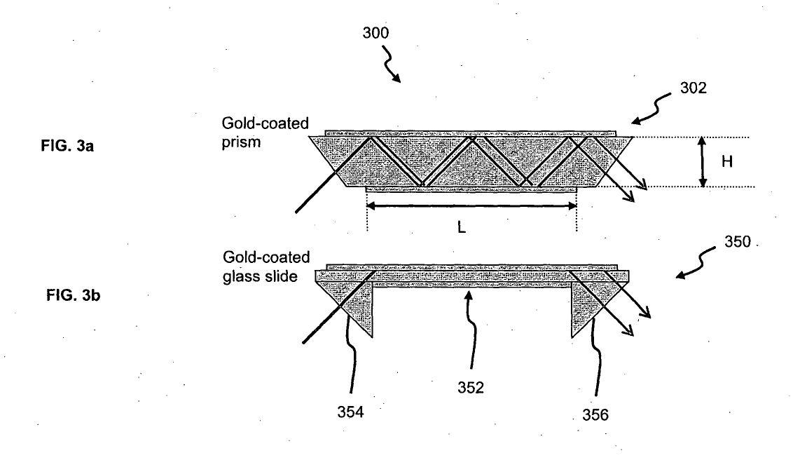

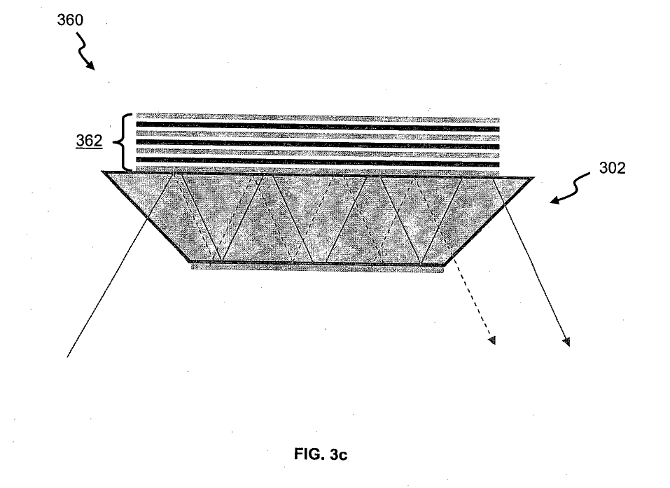

Now with reference to FIGS. 3a, 3b and 3c, the sensing optics 116 includes prisms made of high-refractive-index glass (e.g. BK7, SF10 glasses, or transparent polymeric materials such as polycarbonate and etc). In particular, a first design 300 (as shown in FIG. 3a), a second design 350 (as shown in FIG. 3b), or a third design 360 (as shown in FIG. 3c), may be implemented for the sensing optics 116, depending on requirements of an intended application. The first design 300 comprises using a longitudinal piece of prism 302 (hereinafter “longitudinal prism”), whereas the second design 350 includes using a piece of glass slide 352 with coupling and decoupling prisms 354, 356 attached at respective ends of the glass slide 352. On the other hand, the third design 360 is based on the first design 300, to be elaborated below. The coupling prism 354 is where the laser beam is received into the glass slide 352 while the decoupling prism 356 is where the laser beam (now split into the P-polarized laser beam and S-polarized laser beam) leaves the glass slide 352. At least one reflection surface of the sensing optics 116 (i.e. at the longitudinal prism 302 or the glass slide 352, depending on which design 300, 350 is adopted) arranged to cause internal reflection of the received laser beam is coated with at least one layer of precious metal (e.g. gold or silver), and each layer may about 40 nm to 50 nm thick in this case. To be clear, the sensing optics 116 is externally coated with the said layer(s) of precious metal(s). For this embodiment, the reflection surfaces are coated with gold. The said longitudinal prism 302 used may be one typically used in conventional SPR setups. In order to enlarge the GH-shift, a multiple reflection mechanism is proposed and used in the sensing optics 116 for accumulation of GH-shift so that detection sensitivity is increased. So, for the first design 300, a maximal base length (L) and a height (H) of the longitudinal prism 302 is arranged to satisfy the following conditions as set out in equation (2):

(2n)H*tan(θ)<L<(2n+2)H*tan(θ) (2)

wherein n (=0, 1, 2, 3 . . . ) represents a number of (internal) reflections at one surface of the longitudinal prism 302, tan( ) represents the trigonometric tangent function, and θ is the SPR angle which is tuned by the reflection mirror 112 to get an optimal GH-shift.

A magnitude of amplification is determined by n, and the maximum GH-shift is 2H*tan(θ), for the scale of the thickness of the longitudinal prism 302 (for the case of FIG. 3a). It is to be appreciated that the purposefully designed and quantitatively controlled multi-reflection for amplification of GH-Shift in the proposed sensing optics 116 is in contrast to random multi-reflection and attenuation of light intensity in waveguide or optical fibre.

If it is desired to increase a number of internal reflections without increasing a length of the sensing optics 116 for a given value of H, the second design 350 of using the glass slide 352 (with gold-coated reflection surfaces) may alternatively be adopted over the first design 300 for the sensing optics 116. It is to be appreciated that index matching liquid is also usable to adapt the coupling and decoupling prisms 354, 356 to the said glass slide 352 in order to avoid any possible undesirable stray internal reflection from occurring. It is to be appreciated that the large number of internal reflections in the glass slide 352 of FIG. 3b are not shown for simplicity of illustration.

If it is desired to further amplify the surface plasmon effect, multiple layers 362 of different metals may be coated onto one or both reflection surfaces, as per the third design 360 depicted in FIG. 3c. As mentioned, the third design 360 is based on the first design 300, and so the one or both reflection surfaces are references to the associated reflection surfaces of the longitudinal prism 302 of FIG. 3a. In this instance, the multiple layers 362 are coated on only one reflection surface of said longitudinal prism 302, and alternate layers in the multiple layers 362 are coated with a same type of metal, for example, the even layers are coated with gold, while the odd layers are coated with silver. For good order, it is however to be appreciated the above is not to be construed as limiting; indeed other different suitable combinations of metal coating for the multiple layers 362 may also be possible (e.g. more than two metals may be used), depending on applications. Also, it is to be appreciated that the discussed concept of FIG. 3c may be adoptable, mutatis mutandis, to the second design 350 as well.

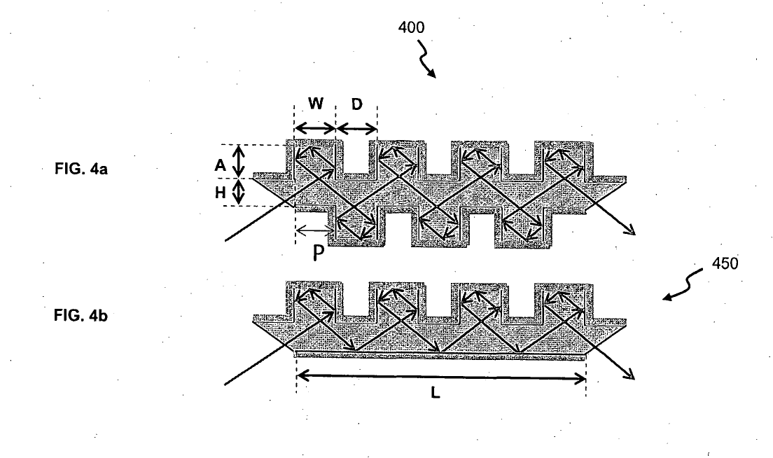

Further yet, a number of multiple reflections generated (in the prism 302 or the glass slide 352) may be improved by forming at least one additional featured surface on at least one reflection surface of the sensing optics 116, in which FIGS. 4a and 4b depict usage of multiple featured surfaces. The definition of featured surface means that the reflection surface is arranged with at least one raised feature (e.g. a protrusion) so as to provide further reflection surfaces to improve the number of multiple internal reflections. Using the prism 302 of the first design 300 as an example, FIG. 4a shows a first variant prism 400 whereby the multiple featured surfaces are formed on both opposing long sides (parallel to the longitudinal axis) of the prism 302, whilst FIG. 4b show a second variant prism 450 whereby the multiple featured surfaces are formed only on one long side of the prism 302. In particular, the featured surfaces to be formed on the said long side(s) may be of any suitable shape, such as zig-zag or polygonal shape. The width (W), distance between adjacent features (D), height (A) and displacement (P) of each feature surface formed on at least one long side of the prism 302 are arranged to allow more multiple internal reflections to occur based on the given maximal base length (L) and height (H) of the prism 302. It is to be appreciated that each internal reflection (of the laser beam) that occurs further amplifies the GH-shift by once, which thus then enables a large extent of amplification to be accumulated eventually.

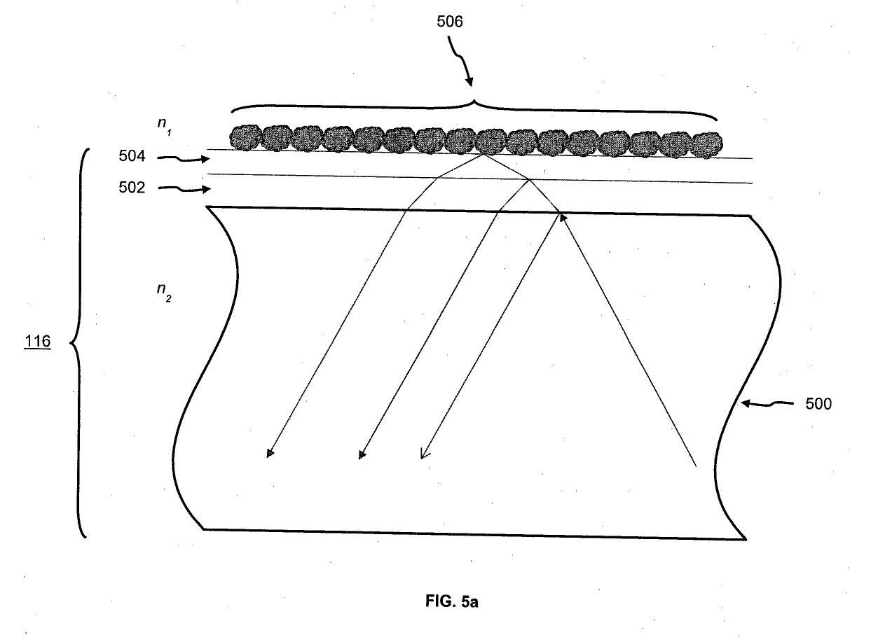

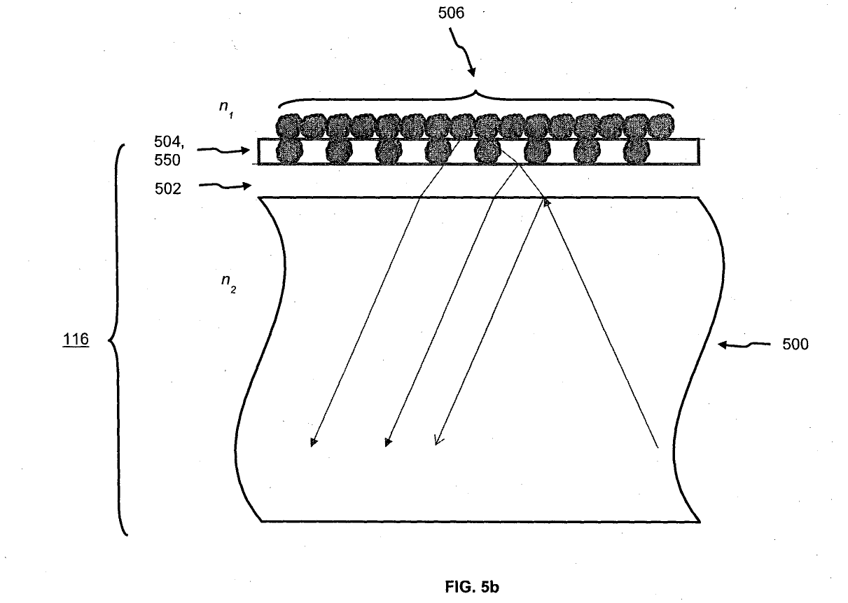

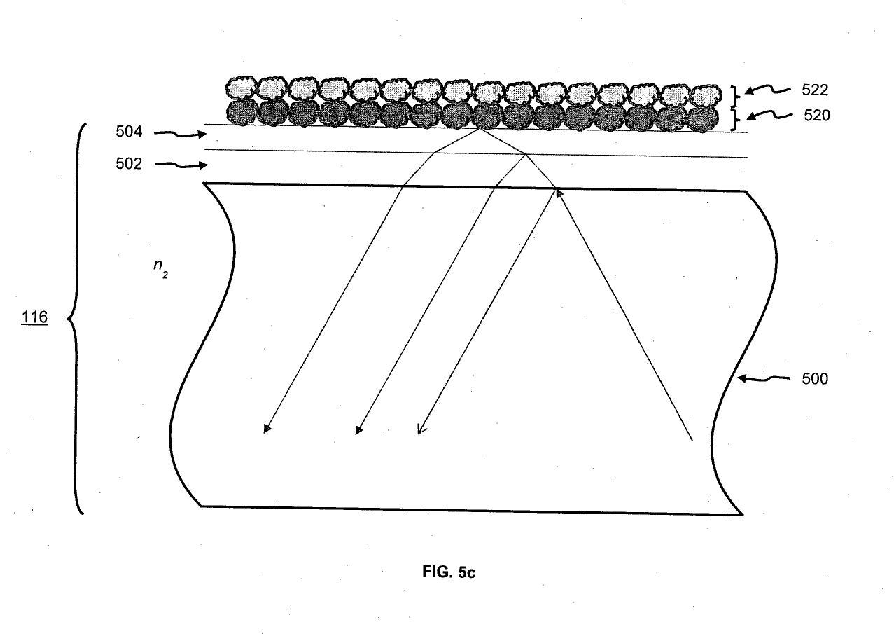

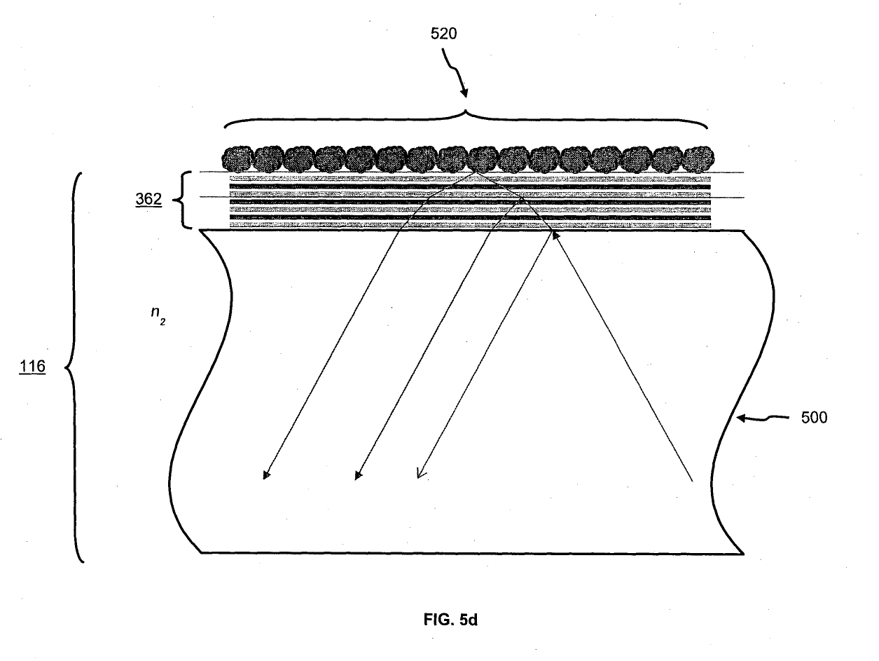

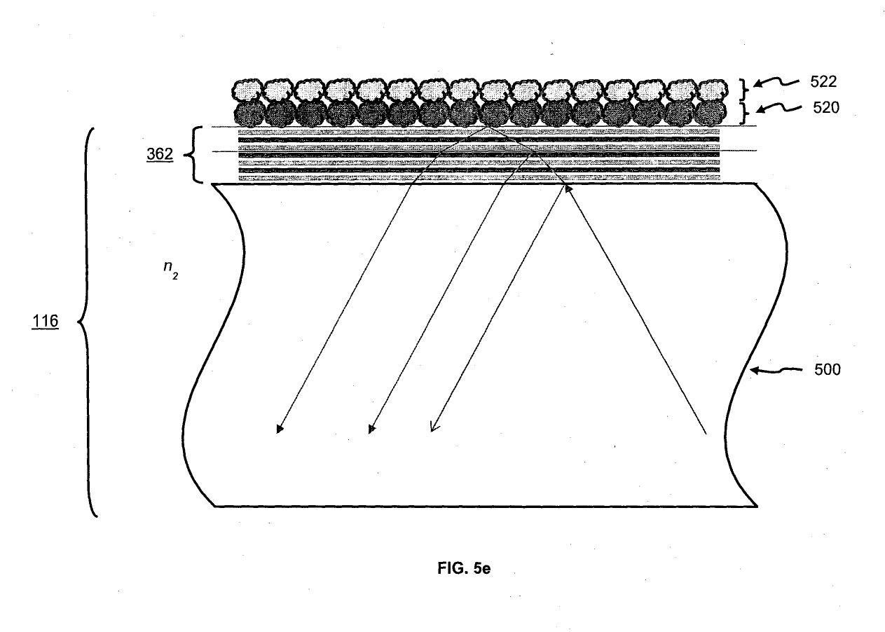

On the afore mentioned coating of the reflection surfaces with a layer of precious metal, the precious metal coated may be as a single layer or as multiple layers. In FIG. 5a, a first metal layer 502 is arranged to be in direct contact with the dielectric material 500 (e.g. glass or plastic) from which the sensing optics 116 is formed, and a second metal layer 504 is arranged immediate adjacent the first metal layer 502 but in opposition to the dielectric material 500 is located. To again clarify, the sensing optics 116 is largely made of the dielectric material 500. It is also to be appreciated that the first metal layer 502 and second metal layer 504 are respective coatings of different types of suitable metals. The first metal layer 502 is a full layer that completely covers the second metal layer 504. For example, the first metal layer 502 and second metal layer 504 may respectively be formed from coatings of gold and silver. Then samples 506 (n₁) suspended in a medium (i.e. gas or liquid) are arranged to be in contact with the second metal layer 504. The samples 506 collectively represent the target specimen to be analysed using the proposed device 100. Alternatively, at least one metal layer may be configured to include a porous layer (regularly/irregularly) covering some portions of another adjacent metal layer, for example in FIG. 5b, the second metal layer 504 in FIG. 5a now includes a porous metal layer 550. Thus the porous metal layer 550 is arranged within the second metal layer 504. It is to be appreciated that the first metal layer 502, second metal layer 504 and porous metal layer 550 are all formed from different types of suitable metal coatings. For example, the first metal layer 502, second metal layer 504 and porous metal layer 550 may respectively be formed from coatings of gold, silver and aluminium. This said porous structure of the porous metal layer 550 allows the samples 506 to be in contact with the metals in the first metal layer 502, second metal layer 504 and porous metal layer 550. Particularly, through the medium, the samples 506 form an interface with the metals in the first metal layer 502, second metal layer 504 and porous metal layer 550. For example, if the sensing optics 116 is implemented based on the first design 300 using the longitudinal prism 302, and that the samples 506 may be suspended in a drop of water solution, then the drop of water solution is arranged to be on the longitudinal prism 302.

Further alternatively, as shown in FIG. 5c (which is based on the arrangement in FIG. 5a), instead of having the samples 506 pre-arranged, there is now arranged at least one analyte binding layer 520 in the medium, which is in contact with the second metal layer 504 as afore discussed. The purpose of having the analyte binding layer 520 is so to capture desired analyte molecules 522 onto the relevant surfaces of the sensing optics 116 for detection and analysis. That is, in operation, the desired analyte molecules 522 will accordingly bind with the analyte binding layer 520. Needless to say, this arrangement is also, mutatis mutandis, applicable to the arrangement in FIG. 5b, as will be appreciated.

Yet alternatively, FIG. 5d shows another variation which is based on the arrangement in FIG. 5c, except that the first metal layer 502 and second metal layer 504 are now replaced by the multiple layers 362 of metal coatings as already above discussed with reference to FIG. 3c (and hence not repeated for brevity). FIG. 5e shows the desired analyte molecules 522 binding with the analyte binding layer 520, as will be appreciated.

Laser Sources

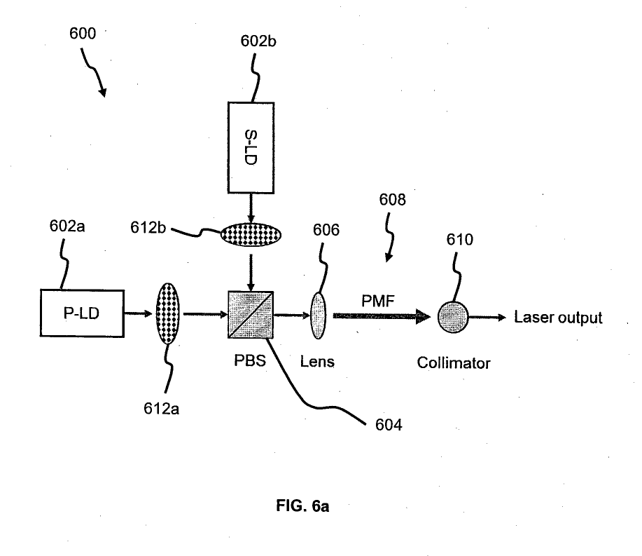

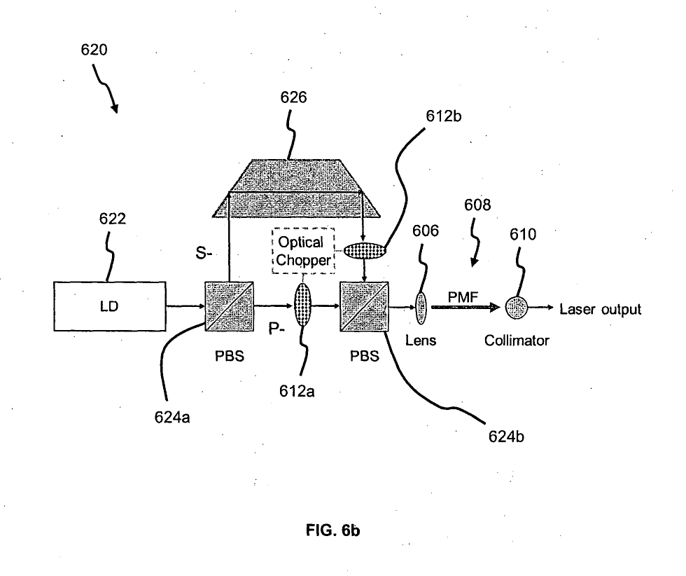

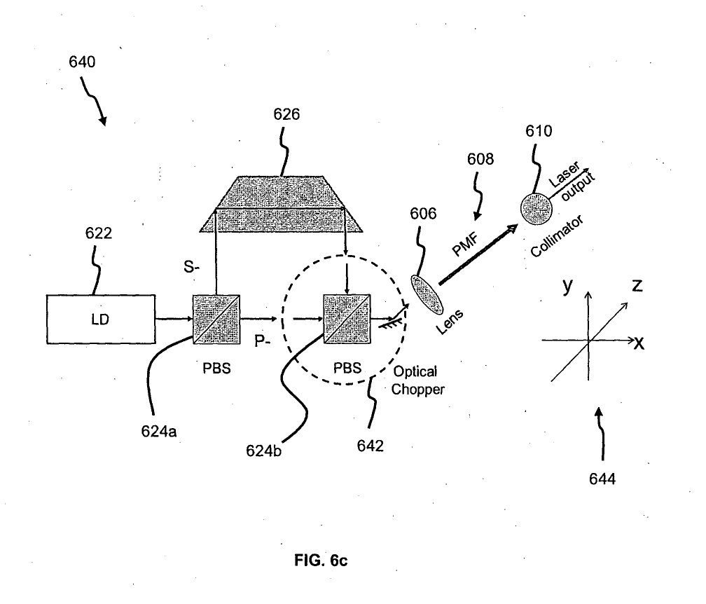

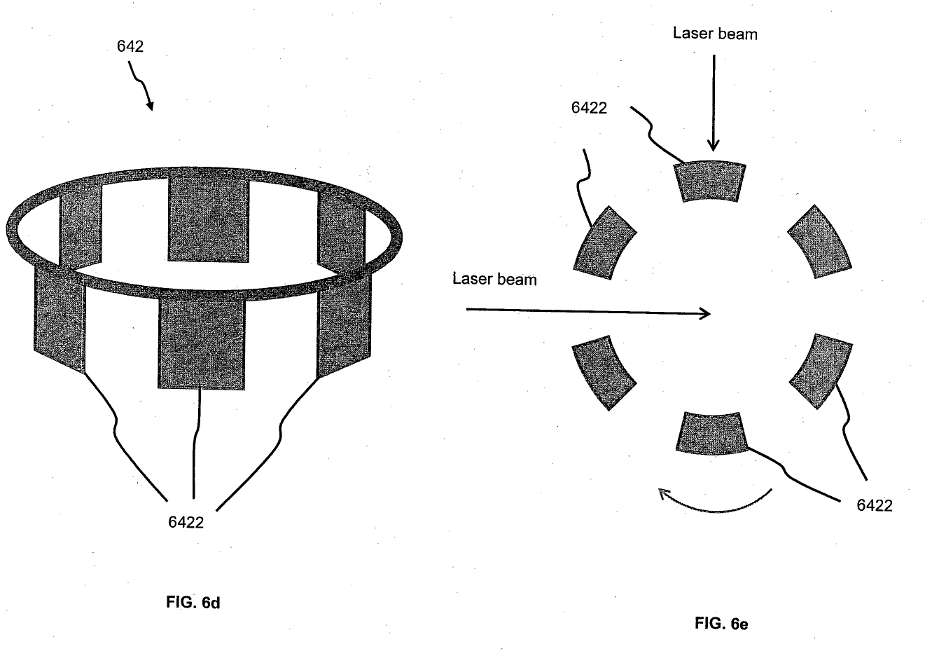

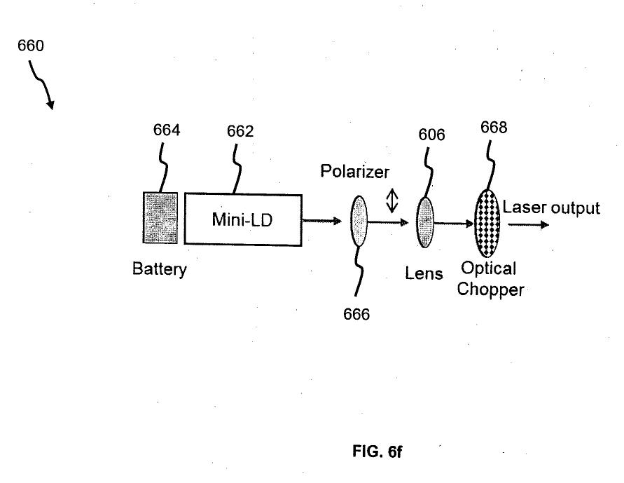

Different configurations are adoptable for the laser source 104 as desired, which are respectively shown in FIGS. 6a to 6e, and to be elaborated individually below. In FIG. 6a, a first configuration 600 as depicted is arranged to generate a coupled laser beam, and is more suited for desktop applications since the first configuration 600 is fairly bulky. The coupled laser beam is generated by using two cross-polarized (P- and S-) laser diodes (LDs) 602a, 602b, a polarizing beam splitter (PBS) 604 (which is used as an optical coupler), a focusing lens 606, a polarization maintaining fibre (PMF) 608 and a collimator 610 to generate the coupled laser beam, which are operationally arranged in the mentioned sequence. In addition, two (first and second) optical choppers 612a, 612b driven by 180°-out-of-phase square waves are respectively arranged at the P-LD 602a and S-LD 602b to modulate corresponding laser beams generated by the P-LD 602a and S-LD 602b. The P-LD 602a and S-LD 602b are periodically modulated to be switched on alternately, which means that when the P-LD 602a is switched on, the S-LD 602b is then switched off, and vice versa. The P-LD 602a is for arranged for sensing purpose and the S-LD 602b is arranged for referencing purpose, as no SPR is generated by S-polarized light. The modulated P- and S-polarized laser beams are next optically coupled by the PBS 604 and then output to the collimator 610 (through the focusing lens 606 and the PMF 608) to obtain a coupled laser beam (of the required characteristics).

The remaining configurations will be described hereinafter. For the sake of brevity, description of like elements, functionalities and operations that are common between the different configurations are not repeated; reference will instead be made to similar parts of the relevant configuration(s).

For a second configuration 620 shown in FIG. 6b, which includes a non-polarized laser diode (LD) 622, first and second PBSs 624a, 624b, the focusing lens 606, the PMF 608 and the collimator 610 arranged in the mentioned sequence. The first and second PBSs 624a, 624b are functionally and structurally similar to the PBS 604 of the first configuration 600. The non-polarized LD 622 generates a laser beam which is then optically split into P- and S-polarized beams using the first PBS 624a. The S-polarized laser beam is then optically reflected using a prism 626 and thereafter modulated using the second optical chopper 612b before being received into the second PBS 624b. On the other hand, the P-polarized laser beam is modulated using the first optical chopper 612a and received into the second PBS 624b. The modulated P- and S-polarized beams are optically coupled together by the second PBS 624b and output to the collimator 610 (through the focusing lens 606 and the PMF 608).

For a third configuration 640 shown in FIG. 6c, which is largely similarly to the second configuration 620 except that the first and second optical choppers 612a, 612b are now omitted and in place is at least one perpendicular optical chopper 642 arranged at the second PBS 624b to modulate the P- and S-polarized beams, before the modulated P- and S-polarized beams are then optically coupled through the second PBS 624b. Also, the focusing lens 606, the PMF 608 and the collimator 610 are now arranged to be oriented in a Z direction, which is to be understood with reference to the three-dimensional Cartesian coordinate axes 644 as shown on the right side of FIG. 6c. More specifically, as shown in FIG. 6d, the perpendicular optical chopper 642 includes chopper blades 6422 mounted perpendicularly to the spinning plane of the optical chopper 642 and a direction of approach of laser beams. The perpendicular optical chopper 642 is configured to be operated such that when any one piece of the chopper blades 6422 starts blocking one (e.g. P-) laser beam, one of the other chopper blades 6422 just finishes blocking the other (e.g. S-) laser beam, as shown in FIG. 6e. FIG. 6e shows a plan view of FIG. 6d, as seen from the direction of the chopper blades 6422. It is also to be appreciated that the coupled laser beam is however not blocked by the chopper blades 6422.

For a fourth configuration 660 shown in FIG. 6f, a miniaturized single-beam polarized laser diode 662 (powered by a battery 664) is used as a portable version of the laser source 104. The laser beam generated by the single-beam polarized laser diode 662 is regulated by a P-polarizer 666 and thereafter by the focusing lens 606. It is to be appreciated that in this case, the S-polarized laser beam to be used for referencing is optional. Further, it is also highlighted that the fourth configuration 660 is mainly used in instant sensing scenarios, and an on-site referencing of the P-polarized light against a background/blank sample will be sufficiently effective. Moreover, a non-disrupted polarization switching mechanism is used to modulate the generated laser beam at a frequency of 200˜300 Hz to stabilize a power intensity thereof, while the single-beam polarized laser diode 662 is kept continuously switched on, instead of being switched on and off frequently. Moreover, only one optical chopper 668 (arranged to receive the focused laser beam from the focusing lens 606) is used to generate a final pulsed laser output.

Data Acquisition and Control

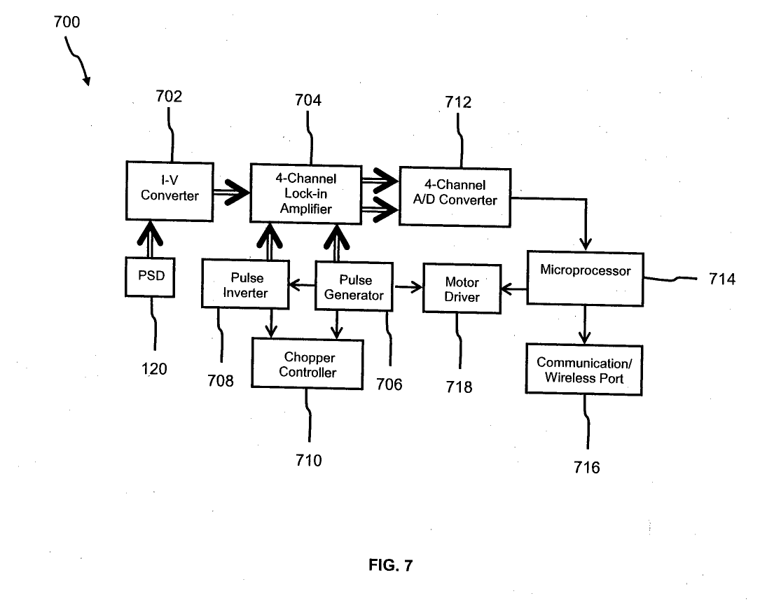

For the processing circuit board 108 (which is electrically coupled to the PSD 120), all necessary electronic components are integrated and implemented on a PCB according to a logic diagram 700 depicted in FIG. 7. In particular, photocurrent outputs from two electrodes of the PSD 120 are first converted into respective two photo-voltage signals by a current-voltage (I-V) converter 702. Then via referencing to an original pulse and an inverted pulse, the two photo-voltage signals are split into four signals by a 4-channel lock-in amplifier 704 to be processed. The significance of processing each signal with the 4-channel lock-in amplifier 704 is to provide a dedicated channel for each signal stream, and is to be appreciated that a reading (relating to position data of the laser beams) is independent of laser intensity variation, so any noise is reduced in addition to signal amplification. The original pulse is generated by a pulse generator 706, which simultaneously provides the original pulse to a pulse inverter 708 to obtain the inverted pulse (which is reversed in amplitude to the original pulse). Specifically, the original and inverted pulses (which are 180 degrees out of phase to each other) serve to provide a pulse reference to the 4-channel lock-in amplifier 704 for the P- and S-polarised beams. The pulse generator 706 and pulse inverter 708 are in turn linked to a chopper controller 710. The pulse inverter 708 provides the inverted pulse to the 4-channel lock-in amplifier 704. Using a proposed direct data acquisition method 800 (for working with the device 100), each individual signal is thereafter measured with the 4-channel lock-in amplifier 704. Particularly, the proposed method 800 directly and independently measures all the four photocurrent signals needed for computation of positions of the laser beams, and so the said positions are not related to laser intensity. Further, any disturbance to the laser intensity is measurable and thus subtractable, and so the determination of positions of laser beams will not be affected. The GH-shift measurement made is regardless of variation in laser intensity, and so low cost lasers are usable.

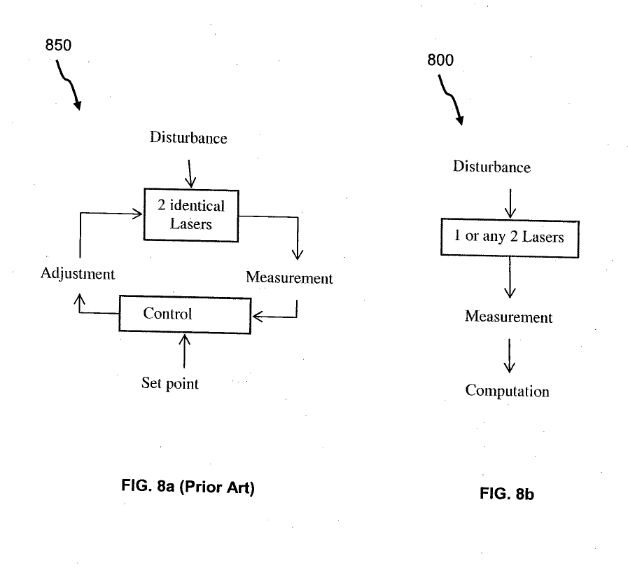

A comparison between the proposed direct data acquisition method 800 and a conventional method 850 (based on prior art) can be seen from FIGS. 8b and 8a respectively. The conventional method 850 is based on feedback control, and so in contrast, the proposed direct data acquisition method 800 is beneficially resistant to Large Magnitude Disturbance (e.g. significant laser intensity drop or failure), systematic error, incidental misplacement of optics and etc. After further undergoing filtering and amplifying, the four said signals (from the 4-channel lock-in amplifier 704) are converted into digital signals by an analog-to-digital (A/D) converter 712, and to be processed by a microprocessor 714. The processed signals are transferred to the computing device 110 via a communication (wired/wireless) port 716 (e.g. an USB or Ethernet port). It is to be appreciated that the pulse generator 706 and pulse inverter 708 are also used to drive the chopper controller 710 to provide switching laser beam output. A stepper motor driver 718 is then pulsed and controlled respectively by the pulse generator 706 and the microprocessor 714. In particular, the stepper motor driver 718 is used to drive/control the stepper motor 202 of FIG. 2.

Thus, a method of analysing a desired specimen using the Goos-Hänchen surface plasmon resonance effect via using the device 100 (of FIG. 1) includes directing a laser beam (generated by the laser source 104) at the sensing optics 116 using the reflection mirror 112, and convex lens 114; internally reflecting the laser beam using the sensing optics 116 to enable interaction between the internally reflected laser beam and the received specimen to cause the internally reflected laser beam to be (GH-)shifted; and finally detecting the (GH-)shifted laser beam using the PSD 120.

Also, a method of manufacturing the device 100 (of FIG. 1) for analysing a desired specimen using the Goos-Hänchen surface plasmon resonance effect includes providing the sensing optics 116 for internally reflecting a laser beam and for receiving the specimen; providing the reflection mirror 112, and convex lens 114 for directing the laser beam at the sensing optics 116 to enable interaction between the internally reflected laser beam and the received specimen to cause the internally reflected laser beam to be (GH-)shifted; providing the PSD 120 for detecting the (GH-)shifted laser beam; and integrally forming the sensing optics 116 with the housing 102 and arranging the reflection mirror 112, convex lens and PSD 120 in the housing 102 to obtain the device 100.

Results Discussion

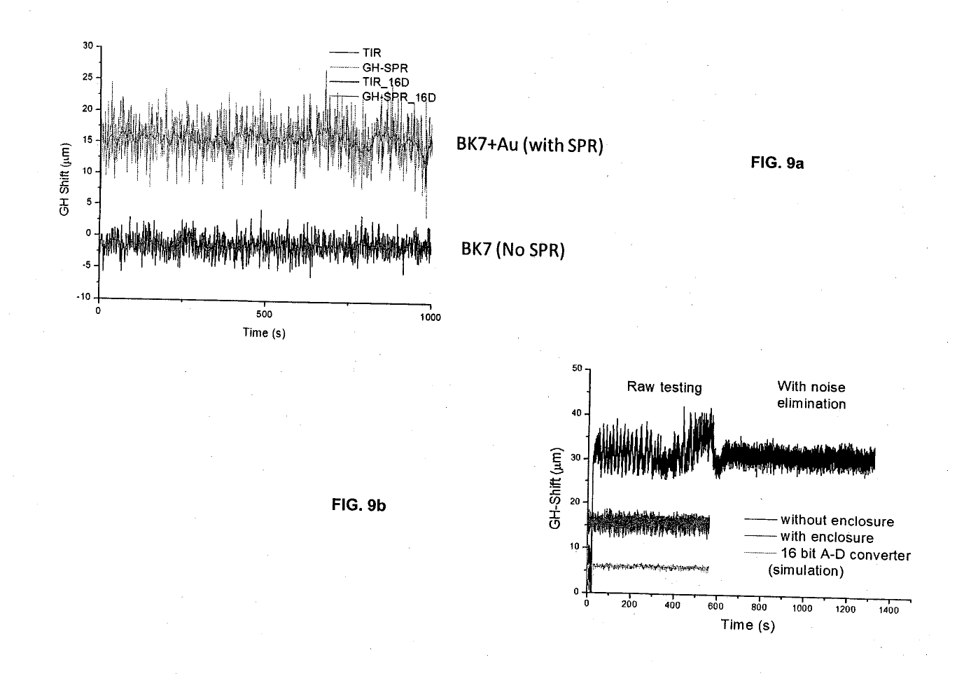

FIG. 9a shows related results obtained, which illustrate that generation of GH-SPR signals (i.e. GH-shift) can be achieved (using the device 100) and a higher GH-shift signal is achievable with coupling to SPR. In FIG. 9b, it is to be highlighted that signals originally with the same GH-shift value are vertically shifted for clearer comparison with the noise level. From FIG. 9b, it can be seen that the housing 102 of the device 100 effectively eliminates noise interferences thus resulting in optimization of the GH-SPR signals generated. Other related simulations were also performed to demonstrate that with use of better electronic components (e.g. a 16-bit A/D converter) quality of the signals obtained may be further improved.

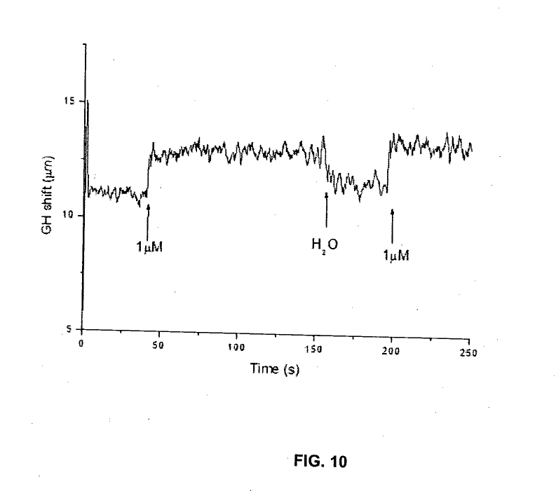

FIG. 10 is a graph measuring response to refractive index changes of the GH-SPR tested with NaCl solution. Using a relationship between refractive index (RI) and concentration of NaCl (8.73*10⁻³ RIU/M), an associated resolution (Rs) is found to be approximately 10⁻⁸ RIU. It is to be appreciated that the RI of the NaCl solution has a linear relationship with its associated concentration (as known in the art), and so the NaCl solution arranged with a specific concentration may then be used to obtain a certain RI, as desired. The value of the optimized Rs is then estimated to be smaller than 10⁻⁹ RIU. It is thus to be appreciated that the value of the Rs obtained for the proposed device 100 is significantly better compared to conventional solutions (which have an Rs value of 4*10⁻⁷ RIU), commercial bulky (desktop) SPR sensors (which have an Rs value of about 10⁻⁶ RIU) or compact/miniaturized SPR sensors (which have an Rs value of about 10⁻⁶ RIU).

In summary, the proposed device 100 enables enhancement and direct measurement of GH shift. Further, the GH shift is optically amplified by precisely generating controlled multiple reflections (using the sensing optics 116 and optical magnifier 118). The necessary optical components and associated mechanical parts are integrated into a compact arrangement and embedded in the (light and water-proof) housing 102 to provide a modular device. The proposed device 100 is able to substantially eliminate interferences from the environment during when performing measurements, and also allows the device 100 to be submerged into liquids for taking direct and onsite measurements since the sensing optics 116 is arranged within the housing 102. Quality and reliability for processing the signals generated (through the device 100) are also enhanced by using the proposed direct data acquisition method 800 which is based on the 4-channel lock-in amplifying technique. Thus the proposed device 100 provides a new option for conducting sensitive chemical and biochemical analysis in laboratory settings. The device 100 also enables chemical/biochemical monitoring to be performed with minimal interference from the environment, and so envisaged applications for the device 100 include online/inline/onsite monitoring of consumable items (e.g. water or food), as well as being usable in the agricultural, environmental, biomedical industries, and also in research and education institutions.

To reiterate, the proposed device 100 has the following advantages. Firstly, the device 100 improves signal quality generated, together with sensitivity and reliability of a GH-SPR setup. Further, the modular design of the device 100 achieved through using an integrated, compact and enclosed sensing arrangement is advantageous over existing solutions which are exposed to environmental disturbances. Also, low cost laser sources can be adopted for the device 100 which consequently reduces costs of the GH-SPR setup. Moreover, using the specifically designed multi-reflection amplification of GH effect, and optical magnifier 118 for further amplification of GH shift are also beneficial over conventional solutions. Yet further, the proposed device 100 uses synchronized optical choppers (instead of TTL control) to switch lasers to reduce noise due to unstable laser intensity.

The described embodiment(s) should not however be construed as limitative. For example, the laser source 104, adaptor 106, processing circuit board 108 and computing device 110 may not be included as part of the said device 100. For the proposed direct data acquisition method 800, it is to be appreciated that detection and signal processing of each of the four signals may not be restricted to using the 4-channel lock-in amplifier 704; instead processing may also be performed using other appropriate configurations or means, e.g. via at least two channels (i.e. using a 2-channel lock-in amplifier, for example in the case of the fourth configuration 660 of FIG. 6f, where a coupled laser is not used and hence 2 channels are then considered sufficient) or even more channels (i.e. using a multiple-channel lock-in amplifier) if desired, based on different requirements. Also, instead of the laser source 104, other suitable light sources that are able to generate coherent light beams are also usable with the device 100.

While the invention has been illustrated and described in detail in the drawings and foregoing description, such illustration and description are to be considered illustrative or exemplary, and not restrictive; the invention is not limited to the disclosed embodiments. Other variations to the disclosed embodiments can be understood and effected by those skilled in the art in practising the claimed invention.

### REFERENCES

[1]. Nylander, C., B. Liedberg, and T. Lind, Sensors and Actuators, 3(1), 79 (1982).
[2]. Goos, F. and H. Hänchen, Ann. Phys. (Leipzig), 1, 333 (1947).
[3]. Yin, X. B., L. Hesselink, Z. W. Liu, N. Fang, and X. Zhang, Applied Physics Letters, 85(3), 372 (2004).
[4]. Raether, H., Surface Plasmons on Smooth and Rough Surfaces and on Gratings 1988, Berlin: Springer.

1. A device for analyzing a specimen using the Goos-Hänchen surface plasmon resonance effect, the device comprising:
a housing;
a sensor for internally reflecting a coherent light beam and for receiving the specimen;
an optical means for directing the coherent light beam at the sensor to enable interaction between the internally reflected coherent light beam and the received specimen to cause the internally reflected coherent light beam to be shifted; and
a detector for detecting the shifted coherent light beam, the sensor being integrally formed with the housing.

2. The device of claim 1, wherein the housing is arranged to be impervious to visible light and water.

3. The device of claim 1, wherein the optical means include a reflection mirror and a focusing lens arranged in a cooperative relationship.

4. The device of claim 1, further comprising a means for generating the coherent light beam, which includes a laser source configured to alternately generate a P-polarized coherent light beam or S-polarized coherent light beam, or a laser source configured to generate a P-polarized coherent light beam.

5. The device of claim 1, further comprising a processor for processing signals generated by the detector based on detection of the shifted coherent light beam,
wherein the processor is configured to divide the signals into a plurality of secondary signals with reference to an original pulse and an amplitude-inverted pulse of the original pulse for noise reduction and signal amplification.

6. The device of claim 1, wherein the detector includes a position sensitive detector.

7. The device of claim 1, wherein the laser source includes a first laser diode configured to generate a P-polarized laser beam, a second laser diode configured to generate an S-polarized laser beam, a modulation means for modulating the P-polarized laser beam and S-polarized laser beam, and a polarizing beam splitter arranged to optically couple the modulated P-polarized laser beam and S-polarized laser beam to obtain a coupled laser beam.

8. The device of claim 1, wherein the laser source includes a laser diode configured to generate a non-polarized laser beam, a first polarizing beam splitter arranged to optically split the non-polarized laser beam into a P-polarized laser beam and a S-polarized laser beam, a modulation means for modulating the P-polarized laser beam and S-polarized laser beam, and a second polarizing beam splitter arranged to optically couple the modulated P-polarized laser beam and S-polarized laser beam to obtain a coupled laser beam.

9. The device of claim 8, wherein the modulation means includes at least two optical choppers for respectively modulating the P-polarized laser beam and S-polarized laser beam, the optical choppers configured to be driven by 180°-out-of-phase square waves.

10. The device of claim 8, wherein the modulation means includes at least one perpendicular optical chopper for modulating both the P-polarized laser beam and S-polarized laser beam.

11. The device of claim 1, wherein the laser source includes a laser diode configured to generate a polarized laser beam, a P-polarizer to optically polarize the polarized laser beam to obtain a P-polarized laser beam, and a modulation means for modulating the P-polarized laser beam.

12. The device of claim 7, wherein the modulation means includes at least one optical chopper.

13. The device of claim 1, wherein the sensor includes a plurality of optical surfaces for internally reflecting the coherent light beam, at least one of the plurality of optical surfaces is metallically coated to increase an amount of the internal reflection of the coherent light beam.

14. The device of claim 13, wherein the sensor includes an optical prism configured with the plurality of optical surfaces, or an optical substrate configured with the plurality of optical surfaces, or an optical substrate configured with a plurality of raised features corresponding to the plurality of optical surfaces.

15. The device of claim 13, wherein the plurality of optical surfaces includes at least two optical surfaces.

16. The device of claim 13, wherein at least one of the plurality of optical surfaces is arranged to further include a porous layer.

17. The device of claim 13, wherein the at least one of the plurality of optical surfaces is metallically coated includes being arranged to be coated with gold or silver.

18. A method of analyzing a specimen using the Goos-Hänchen surface plasmon resonance effect by using the device of claim 1, wherein the specimen is received by the sensor, the method comprises:
directing a coherent light beam at the integrally formed sensor using the optical means;
internally reflecting the coherent light beam using the sensor to enable interaction between the internally reflected coherent light beam and the received specimen to cause the internally reflected coherent light beam to be shifted; and
detecting the shifted coherent light beam using the detector.

19. A method of manufacturing a device configured for analyzing a specimen using the Goos-Hänchen surface plasmon resonance effect, the method comprises:
providing a sensor for internally reflecting a coherent light beam and for receiving the specimen;
providing an optical means for directing the coherent light beam at the sensor to enable interaction between the internally reflected coherent light beam and the received specimen to cause the internally reflected coherent light beam to be shifted;
providing a detector for detecting the shifted coherent light beam; and
integrally forming the sensor with a housing and arranging the optical means and detector in the housing to obtain the device.

20. A sensor for analyzing a specimen using the Goos-Hänchen surface plasmon resonance effect, the sensor comprising:
a plurality of optical surfaces for internally reflecting a coherent light beam,
wherein at least one of the plurality of optical surfaces is metallically coated to increase an amount of the internal reflection of the coherent light beam.

21. The sensor of claim 20, being an optical prism configured with the plurality of optical surfaces, or an optical substrate configured with the plurality of optical surfaces, or an optical substrate configured with a plurality of raised features corresponding to the plurality of optical surfaces.

22. The sensor of claim 20, wherein the plurality of optical surfaces includes at least two optical surfaces.

23. The sensor of claim 20, wherein at least one of the plurality of optical surfaces is arranged to further include a porous layer.

24. The sensor of claim 20, wherein the at least one of the plurality of optical surfaces is metallically coated includes being arranged to be coated with gold or silver.
